(19) United States
(12) Patent Application Publication
(10) Pub. No.: US 2026/0021437 A1
(43) Pub. Date: Jan. 22, 2026

(54) EVAPORATED FUEL TREATMENT DEVICE

(71) Applicant: FUTABA INDUSTRIAL CO., LTD., Okazaki-shi (JP)

(72) Inventor: Koji Iwamoto, Okazaki-shi, Aichi (JP)

(21) Appl. No.: 19/250,282

(22) Filed: Jun. 26, 2025

(30) Foreign Application Priority Data
Jul. 19, 2024 (JP) 2024-116000

(51) Int. Cl. B01D 53/04; F02M 33/00

(52) U.S. Cl. CPC B01D 53/0415; F02M 33/00; B01D 2257/708; B01D 2259/4566

(57) ABSTRACT

An evaporated fuel treatment device includes an adsorbent, an inner case, an outer case, and an elastic member. The adsorbent is in the form of a mass. The adsorbent is configured to adsorb evaporated fuel. The inner case has a tubular shape. The inner case is configured to hold the adsorbent in a state where at least a portion of the adsorbent is disposed inside the inner case. The outer case houses the adsorbent and the inner case. The elastic member is disposed between an outer surface of the inner case and an inner surface of the outer case. The elastic member surrounds both the inner case and the adsorbent in circumferential directions of the inner case.

### CROSS-REFERENCE TO RELATED APPLICATIONS

This application claims the benefit of Japanese Patent Application No. 2024-116000 filed on Jul. 19, 2024 with the Japan Patent Office, the entire disclosure of which is incorporated herein by reference.

### BACKGROUND

The present disclosure relates to an evaporated fuel treatment device.

For example, Japanese Examined Utility Model Application Publication No. H6-25546 discloses an evaporated fuel treatment device including a case and granular activated carbon. The activated carbon is configured to adsorb evaporated fuel. The activated carbon is filled in the case.

### SUMMARY

An evaporated fuel treatment device may include an adsorbent in the form of a mass. The adsorbent in the form of a mass is configured to adsorb evaporated fuel. The adsorbent in the form of a mass is disposed inside the case.

In such an evaporated fuel treatment device, a gap may be formed between an inner surface of the case and an outer surface of the adsorbent in a case where the case has expanded due to heat.

In one aspect of the present disclosure, it is desirable, in the evaporated fuel treatment device including the adsorbent in the form of a mass, to inhibit formation of the gap between the inner surface of the case and the outer surface of the adsorbent.

One mode of the present disclosure is an evaporated fuel treatment device including an adsorbent, an inner case, an outer case, and an elastic member. The adsorbent is in a form of a mass. The adsorbent is configured to adsorb evaporated fuel. The inner case has a tubular shape. The inner case is configured to hold the adsorbent in a state where at least a portion of the adsorbent is disposed inside the inner case. The outer case houses the adsorbent and the inner case. The elastic member is disposed between an outer surface of the inner case and an inner surface of the outer case. The elastic member surrounds both the inner case and the adsorbent in circumferential directions of the inner case.

With such a configuration, it is possible, in the evaporated fuel treatment device including the adsorbent in the form of a mass, to inhibit formation of a gap between an inner surface of the inner case and an outer surface of the adsorbent.

In one mode of the present disclosure, the elastic member may be disposed between the outer surface of the inner case and the inner surface of the outer case in a state where the elastic member is compressed by the outer case in a radially inward direction of the inner case as a result of the inner case being housed in the outer case. In such a configuration, it is possible to further inhibit the formation of the gap between the inner surface of the inner case and the outer surface of the adsorbent.

In one mode of the present disclosure, a groove may be formed on the outer surface of the inner case. The elastic member may be an annular member that is disposed in the groove. In such a configuration, it is possible to inhibit displacement of the elastic member relative to the inner case. Consequently, it is possible to further inhibit the formation of the gap between the inner surface of the inner case and the outer surface of the adsorbent.

In one mode of the present disclosure, the elastic member may include a tube portion and a flange portion. The tube portion has a tubular shape and covers the outer surface of the inner case. The flange portion extends from the tube portion in a radially outward direction of the tube portion and is continuously formed around an entire circumference of the tube portion in its circumferential directions. In such a configuration, it is possible to inhibit displacement of the elastic member relative to the outer case. Consequently, it is possible to further inhibit the formation of the gap between the inner surface of the inner case and the outer surface of the adsorbent.

In one mode of the present disclosure, a thermal expansion coefficient of the inner case may equal to or greater than a thermal expansion coefficient of the outer case. In such a configuration, it is possible to further inhibit the formation of the gap between the inner surface of the inner case and the outer surface of the adsorbent.

In one mode of the present disclosure, a length of the adsorbent along gas flow directions may be smaller than an equivalent diameter of a cross-section of the adsorbent. The cross-section is perpendicular to the gas flow directions. In such a configuration, it is possible to inhibit the formation of the gap between the inner surface of the inner case and the outer surface of the adsorbent while reducing ventilation resistance of the adsorbent.

In one mode of the present disclosure, the outer case may include an atmosphere port that is open to an atmosphere, and an atmosphere-side adsorption chamber that is directly coupled to the atmosphere port. The adsorbent and the elastic member may be housed in the atmosphere-side adsorption chamber. In such a configuration, it is possible to inhibit the formation of the gap between the inner surface of the inner case and the outer surface of the adsorbent that is adjacent to the atmosphere port.

In one mode of the present disclosure, the outer case may include a surrounding wall portion, a first blocking wall portion, and a second blocking wall portion, and may further include at least one of a first supporting column portion, and a second supporting column portion. The surrounding wall portion has a tubular shape and surrounds the adsorbent and the inner case. The surrounding wall portion includes a first opening located on one side in its axial directions and a second opening located on the other side in its axial directions. The first blocking wall portion has a plate shape and partially blocks the first opening. The second blocking wall portion has a plate shape and partially blocks the second opening. The first supporting column portion extends from the first blocking wall portion toward the second blocking wall portion. The second supporting column portion extends from the second blocking wall portion toward the first blocking wall portion. In such a configuration, it is possible to restrict movement of the adsorbent in the axial directions of the surrounding wall.

### BRIEF DESCRIPTION OF THE DRAWINGS

Example embodiments of the present disclosure will be described hereinafter with reference to the accompanying drawings, in which:

FIG. 1 is a schematic cross-sectional view of an evaporated fuel treatment device of a first embodiment;

FIG. 2 is a schematic partial cross-sectional view of the evaporated fuel treatment device of the first embodiment;

FIG. 3A is a schematic partial cross-sectional view of the evaporated fuel treatment device of the first embodiment in a state where the outer case has expanded due to heat;

FIG. 3B is a schematic partial cross-sectional view of the evaporated fuel treatment device of the first embodiment in a state where the inner case tries to expand due to heat;

FIG. 4 is a schematic partial cross-sectional view of an evaporated fuel treatment device of a second embodiment;

FIG. 5 is a side view of an elastic member of the second embodiment;

FIG. 6 is a schematic partial cross-sectional view of an evaporated fuel treatment device of a third embodiment; and

FIG. 7 is a schematic partial cross-sectional view of an evaporated fuel treatment device of a fourth embodiment.

### DETAILED DESCRIPTION OF EXEMPLARY EMBODIMENTS

### First Embodiment

### [1-1. Configuration]

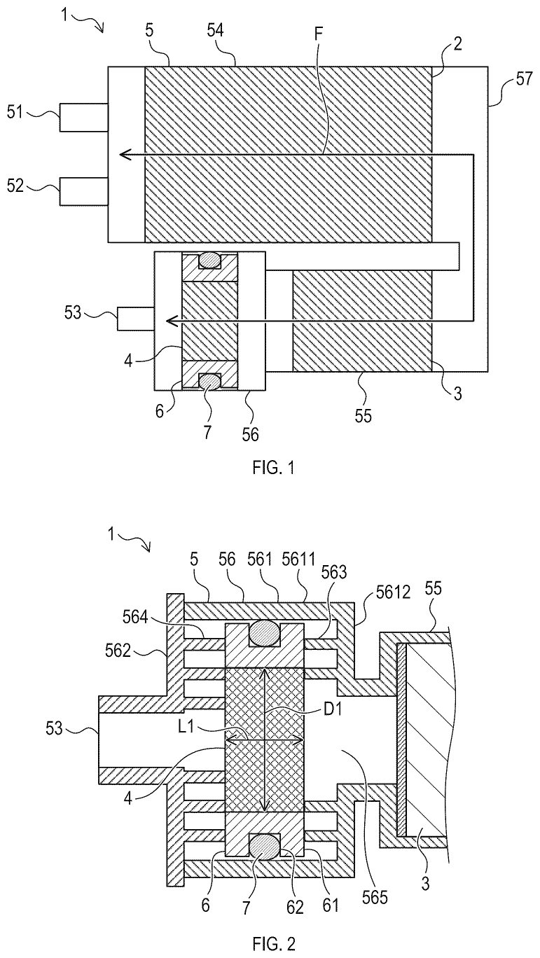

An evaporated fuel treatment device 1 shown in FIG. 1 is configured to be mounted in a vehicle. The evaporated fuel treatment device 1 is configured as a canister that adsorbs and desorbs evaporated fuel generated in a fuel tank of the vehicle. The evaporated fuel treatment device 1 includes a first adsorbent 2, a second adsorbent 3, a third adsorbent 4, an outer case 5, an inner case 6, and an elastic member 7.

The first adsorbent 2, the second adsorbent 3, and the third adsorbent 4 are configured to adsorb the evaporated fuel. At least the third adsorbent 4, among the first adsorbent 2, the second adsorbent 3, and the third adsorbent 4, is in the form of a mass. A specific example of the adsorbent in the form of a mass is a molded body in which fibrous activated carbon is molded into a mass. An external shape of the third adsorbent 4 is a columnar shape. The first adsorbent 2 and the second adsorbent 3 may be, for example, in the form of a mass or in the form of granules. A specific example of the adsorbent in the form of granules is aggregates of granular activated carbon.

The outer case 5 is a member that defines a space therein. The outer case 5 includes an inner surface. The inner surface of the outer case 5 includes a surface or surfaces of the outer case 5 facing the space inside the outer case 5. The outer case 5 is, for example, made of synthetic resin. A specific example of the synthetic resin is polyamide resin such as PA66. The outer case 5 includes a charge port 51, a purge port 52, an atmosphere port 53, a first adsorption chamber 54, a second adsorption chamber 55, a third adsorption chamber 56, and a communication passage 57. Each of the first adsorption chamber 54, the second adsorption chamber 55, and the third adsorption chamber 56 includes an inner surface. The inner surface of each of the first adsorption chamber 54, the second adsorption chamber 55, and the third adsorption chamber 56 includes a surface or surfaces facing a space inside the respective chamber. The inner surface of each of the first adsorption chamber 54, the second adsorption chamber 55, and the third adsorption chamber 56 is a part of the inner surface of the outer case 5.

The charge port 51 is configured to be coupled to the fuel tank of the vehicle via a pipe. The charge port 51 is configured to take the evaporated fuel generated in the fuel tank into the evaporated fuel treatment device 1. The charge port 51 functions as an inflow port for gas containing the evaporated fuel.

The purge port 52 is configured to be coupled to an intake pipe of an engine of the vehicle via a purge valve. The purge port 52 is configured to supply the evaporated fuel that is in the evaporated fuel treatment device 1 to the engine.

The atmosphere port 53 is open to the atmosphere. The atmosphere port 53 is configured to discharge air from which the evaporated fuel has been removed into the atmosphere. Furthermore, the atmosphere port 53 is configured to take in external air (that is, purge air). As a result of the atmosphere port 53 taking in the air (that is, purging), the adsorbed evaporated fuel is released and supplied to the engine via the purge port 52.

The first adsorption chamber 54 houses the first adsorbent 2. The first adsorption chamber 54 is directly coupled to the charge port 51 and the purge port 52. Being “directly coupled to a port” means being coupled to the port without any other interposing chambers. The same applies hereinafter. The first adsorption chamber 54 corresponds to a main chamber having the largest volume among the first adsorption chamber 54, the second adsorption chamber 55, and the third adsorption chamber 56.

The second adsorption chamber 55 houses the second adsorbent 3. The second adsorption chamber 55 corresponds to a subsidiary chamber having a volume smaller than the volume of the first adsorption chamber 54. The second adsorption chamber 55 is in communication with the first adsorption chamber 54 via the communication passage 57. The second adsorption chamber 55 is in communication with the third adsorption chamber 56, which is located on a side of the second adsorption chamber 55 opposite to the communication passage 57.

FIG. 2 is a cross-sectional view of a part, including the third adsorption chamber 56, of the evaporated fuel treatment device 1. As shown in FIG. 2, the third adsorption chamber 56 houses the third adsorbent 4. Similarly to the second adsorption chamber 55, the third adsorption chamber 56 corresponds to a subsidiary chamber having a volume smaller than the volume of the first adsorption chamber 54. The third adsorption chamber 56 includes a main body portion 561, a lid portion 562, at least one bottom-side supporting column portion 563, and at least one lid-side supporting column portion 564.

The main body portion 561 has a bottomed tubular shape. The main body portion 561 may have, for example, a bottomed cylindrical shape or a bottomed polygonal tubular shape. The main body portion 561 includes a surrounding wall 5611 and a bottom wall 5612. The surrounding wall 5611 has a tubular shape. The third adsorbent 4 is disposed in a space surrounded by the surrounding wall 5611. The surrounding wall 5611 corresponds to one example of a surrounding wall portion. The bottom wall 5612 has a plate shape. The bottom wall 5612 partially blocks one opening, among two openings of the surrounding wall 5611 in its axial directions, that is adjacent to the second adsorption chamber 55. A communication hole 565 that is in communication with the second adsorption chamber 55 is formed at the center of the bottom wall 5612. The bottom wall 5612 corresponds to one example of a first blocking wall portion.

The lid portion 562 is configured to partially block an opening of the main body portion 561 having a bottomed tubular shape. The “opening of the main body portion 561” may be referred to as “the other opening, among the two openings of the surrounding wall 5611 in its axial directions, that is located on a side opposite to the one opening partially blocked by the bottom wall 5612”. The lid portion 562 is fixed to the main body portion 561 in a state where the lid portion 562 partially blocks the opening of the main body portion 561. The lid portion 562 corresponds to one example of a second blocking wall portion.

The atmosphere port 53 is provided on the lid portion 562. That is, the third adsorption chamber 56 is directly coupled to the atmosphere port 53. The third adsorption chamber 56 corresponds to one example of an atmosphere-side adsorption chamber. Gas flow directions in the third adsorption chamber 56 coincide with axial directions of the main body portion 561.

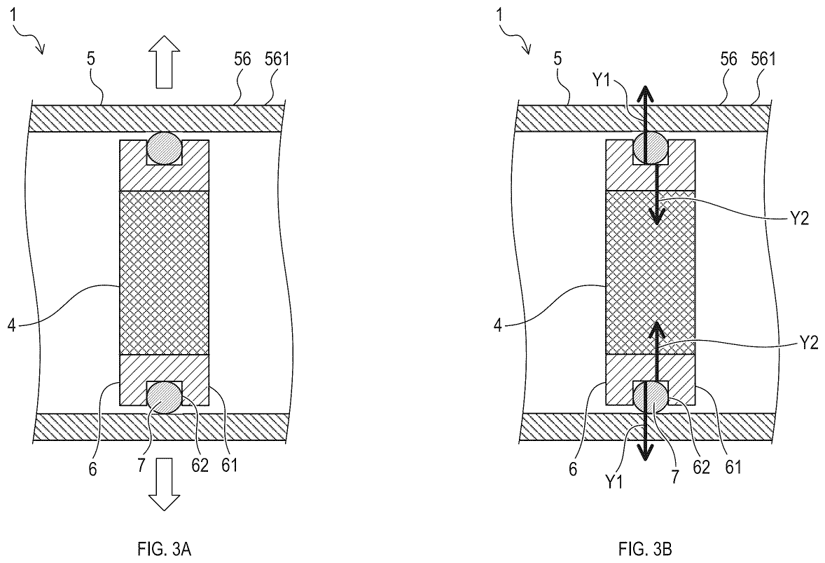

The at least one bottom-side supporting column portion 563 extends from the bottom wall 5612 toward the lid portion 562. The at least one lid-side supporting column portion 564 extends from the lid portion 562 toward the bottom wall 5612. The at least one bottom-side supporting column portion 563 and the at least one lid-side supporting column portion 564 each have, for example, a columnar shape. In a state where the third adsorbent 4 is housed in the main body portion 561, the at least one bottom-side supporting column portion 563 and the at least one lid-side supporting column portion 564 are configured to restrict movement of the third adsorbent 4 in the axial directions of the main body portion 561. The at least one bottom-side supporting column portion 563 corresponds to one example of a first supporting column portion. The at least one lid-side supporting column portion 564 corresponds to one example of a second supporting column portion. In FIGS. 3A and 3B, illustrations of the at least one bottom-side supporting column portion 563 and the at least one lid-side supporting column portion 564 are omitted. FIGS. 3A and 3B are partial cross-sectional views of the third adsorption chamber 56 in a state where the third adsorbent 4 is housed in the third adsorption chamber 56.

As shown in FIG. 1, in the evaporated fuel treatment device 1, the first adsorption chamber 54, the communication passage 57, the second adsorption chamber 55, and the third adsorption chamber 56 form a flow path F for the gas containing the evaporated fuel. In the present embodiment, the flow path F has a substantially U-shape that is bent by the communication passage 57. The second adsorption chamber 55 and the third adsorption chamber 56 are arranged in series along the gas flow directions. In one example, the second adsorption chamber 55 and the third adsorption chamber 56 are arranged on the same straight line. The first adsorption chamber 54 is arranged side by side with the second adsorption chamber 55 and the third adsorption chamber 56. The gas flow directions in each of the first adsorption chamber 54, the second adsorption chamber 55 and the third adsorption chamber 56 are parallel to each other. The gas flow directions in each of the first adsorption chamber 54, the second adsorption chamber 55 and the third adsorption chamber 56 correspond to right-left directions in the plane of the drawing sheet.

As shown in FIG. 2, the inner case 6 is a tubular member. The inner case 6 may have, for example, a circular tubular shape or a polygonal tubular shape. The inner case 6 is made of, for example, synthetic resin. The material of the inner case 6 may be, for example, the same as or different from a material of the outer case 5. A thermal expansion coefficient (linear expansion coefficient) of the inner case 6 is, preferably, equal to or greater than a thermal expansion coefficient of the outer case 5 and, more preferably, greater than the thermal expansion coefficient of the outer case 5.

The inner case 6 includes a surrounding wall 61 and a groove 62.

The surrounding wall 61 has a tubular shape. The surrounding wall 61 includes an inner surface and an outer surface. The inner surface of the surrounding wall 61 includes a surface or surfaces of the surrounding wall 61 facing a space inside the surrounding wall 61. The inner surface of the surrounding wall 61 surrounds a central axis of the surrounding wall 61. The outer surface of the surrounding wall 61 includes a surface or surfaces of the surrounding wall 61 located radially outside of the inner surface of the surrounding wall 61 and surrounding the central axis of the surrounding wall 61.

The groove 62 is a recess formed on the outer surface of the surrounding wall 61. The groove 62 is continuously formed around the entire circumference of the surrounding wall 61 in its circumferential directions. As described below, at least a portion of the third adsorbent 4 is disposed in a space surrounded by the surrounding wall 61. The groove 62 is formed on a portion of the surrounding wall 61 that is configured to surround the third adsorbent 4 in its circumferential directions. In one example, the groove 62 is formed on a center portion of the surrounding wall 61 in axial directions of the surrounding wall 61.

The at least a portion (for example, the whole) of the third adsorbent 4 is disposed in the space surrounded by the surrounding wall 61. That is, the at least a portion (for example, the whole) of the third adsorbent 4 is disposed inside the inner case 6. The inner case 6 is configured to hold the third adsorbent 4 in a state where the at least a portion of the third adsorbent 4 is disposed inside the inner case 6. In one example, the at least a portion of the third adsorbent 4 is press-fitted into the inner case 6, which thereby enables the inner case 6 to hold the third adsorbent 4 in a state where the at least a portion of the third adsorbent 4 is disposed inside the inner case 6. The inner surface of the surrounding wall 61 contacts a surface or surfaces of the third adsorbent 4 that face the inner surface of the surrounding wall 61, that is, an outer surface of the third adsorbent 4 over the entire circumference of the surrounding wall 61 in its circumferential directions.

The inner case 6 is housed in the third adsorption chamber 56 in a state where the inner case 6 holds the third adsorbent 4. That is, both the inner case 6 and the third adsorbent 4 are housed in the third adsorption chamber 56. A central axis of the inner case 6 coincides with a central axis of the main body portion 561. Gas that has flown into the third adsorption chamber 56 passes inside the inner case 6, and consequently, through the third adsorbent 4 in axial directions of the inner case 6.

In a state where the third adsorbent 4 is held by the inner case 6, a length L1 [mm] of the third adsorbent 4 is smaller than an equivalent diameter D1 [mm] of a cross-section of the third adsorbent 4. The length L1 of the third adsorbent 4 is, more specifically, a length L1 of the third adsorbent 4 along the gas flow directions in the third adsorption chamber 56. The equivalent diameter D1 of a cross-section of the third adsorbent 4 is, more specifically, an equivalent diameter D1 of a cross-section, which is perpendicular to the gas flow directions in the third adsorption chamber 56, of the third adsorbent 4. The term “equivalent diameter of a cross-section” as used herein means a value obtained by averaging diameters of true circles having the same area S as that of the cross-section (D=(S/π)^{1/2}×2) in the gas flow directions. The same applies hereinafter.

The elastic member 7 is an annular member having elasticity. The term “annular” as used herein means a shape that is continuous over the entire circumference of the shape. The term “annular” as used herein includes a shape having a circular external shape as viewed from its axial directions and a shape having a polygonal external shape as viewed from its axial directions. The elastic member 7 is configured so as not to allow the evaporated fuel to pass therethrough. The elastic member 7 is made of, for example, elastomer. A specific example of the elastic member 7 is an O-ring.

The elastic member 7 is disposed in the groove 62. In a state before the inner case 6 is housed in the outer case 5, the elastic member 7, which is disposed in the groove 62, extends radially outward beyond the surrounding wall 61. In other words, in a state before the inner case 6 is housed in the outer case 5, a dimension from the central axis of the surrounding wall 61 to a radially outer edge of the elastic member 7 is larger than a dimension from the central axis of the surrounding wall 61 to the outer surface of the surrounding wall 61. Therefore, as a result of the inner case 6 being housed in the outer case 5 in a state where the elastic member 7 is disposed in the groove 62, the elastic member 7 is disposed between an outer surface of the inner case 6 and an inner surface of the outer case 5 in a state where the elastic member 7 is compressed radially inward by the outer case 5. As described above, the groove 62 is formed on the portion of the surrounding wall 61 that surrounds the third adsorbent 4 in its circumferential directions. Therefore, the elastic member 7 surrounds both the inner case 6 and the third adsorbent 4 in circumferential directions of the inner case 6. The elastic member 7 covers a part of the third adsorbent 4 along the axial directions of the inner case 6 from a radially outside of the inner case 6.

The size of the inner case 6 is such that a gap is formed between the outer surface of the surrounding wall 61 and an inner surface of the main body portion 561 in a state where the inner case 6 is housed in the outer case 5. However, due to a dimensional error of the inner case 6 or the outer case 5, the outer surface of the surrounding wall 61 can, for example, partially contact the inner surface of the main body portion 561.

### [1-2. Action]

For example, a heat source, such as a muffler of the vehicle, is disposed in the vicinity of the evaporated fuel treatment device 1. In this case, heat from the heat source may be transferred to the evaporated fuel treatment device 1. Specifically, the heat from the heat source can be transferred from an outer side of the evaporated fuel treatment device 1 to an inner side of the evaporated fuel treatment device 1. The heat may be transferred, for example, to the outer case 5, the inner case 6, and the third adsorbent 4 in this order.

In a case where the heat has been transferred to the outer case 5, as indicated by white arrows in FIG. 3A, the outer case 5 may expand due to the heat. In a case where the thermal expansion coefficient of the outer case 5 and the thermal expansion coefficient of the inner case 6 are substantially equal to each other, the outer case 5, which is closer to the heat source than the inner case 6 is, expands more easily than the inner case 6. This is because the heat from the heat source is more easily transferred to the outer case 5 than to the inner case 6, since the outer case 5 is closer to the heat source than the inner case 6 is.

For example, in the outer case 5, when the third adsorption chamber 56 expands due to the heat, the elastic member 7 expands radially outward to the same extent. This is because a compressive force acting on the elastic member 7 from the outer case 5 is reduced. As a result of the elastic member 7 expanding radially outward, displacement of the inner case 6 and the third adsorbent 4 relative to the third adsorption chamber 56 is inhibited.

In a case where the heat is transferred to the inner case 6 subsequent to the outer case 5, the inner case 6 may try to expand due to the heat. If the inner case 6 has expanded due to the heat, a gap can be formed between the inner surface of the inner case 6 and the outer surface of the third adsorbent 4. In a case where the gap has been formed, a portion of the evaporated fuel can pass through the gap instead of the third adsorbent 4, and consequently, the evaporated fuel adsorption capacity of the evaporated fuel treatment device 1 can be reduced. Furthermore, the third adsorbent 4 can be displaced relative to the inner case 6.

However, when the inner case 6 tries to expand, as shown in FIG. 3B, a compressive force Y1 acts on the elastic member 7 from the inner case 6. Accordingly, a reaction force Y2 acts on the inner case 6 from the elastic member 7. The reaction force Y2 is a force that presses the inner case 6 radially inward, that is, toward the third adsorbent 4. The reaction force Y2 particularly acts on a portion of the inner case 6 in which the inner surface of the inner case 6 faces the outer surface of the third adsorbent 4. This is because the elastic member 7 surrounds both the inner case 6 and the third adsorbent 4 in the circumferential directions of the inner case 6. Thus, radially outward expansion of the portion of the inner case 6 in which the inner surface of the inner case 6 faces the outer surface of the third adsorbent 4 is particularly inhibited by the reaction force Y2. Therefore, formation of a gap between the inner surface of the inner case 6 and the outer surface of the third adsorbent 4 is inhibited.

### [1-3. Effects]

The first embodiment explained above in detail provides the following effects.

(1a) The evaporated fuel treatment device 1 includes the elastic member 7. The elastic member 7 is disposed between the outer surface of the inner case 6 and the inner surface of the outer case 5. Specifically, the elastic member 7 is disposed between the outer surface of the surrounding wall 61 and the inner surface of the main body portion 561. The elastic member 7 surrounds both the inner case 6 and the third adsorbent 4 in the circumferential directions of the inner case 6.

In such a configuration, even if the inner case 6 tries to expand due to the heat, it is possible to make the reaction force Y2 act on the inner case 6 in response to the compressive force Y1 acting on the elastic member 7. Therefore, it is possible to inhibit the expansion of the inner case 6 due to the heat. Particularly, it is possible to inhibit the expansion of the portion of the inner case 6 in which the inner surface of the inner case 6 faces the outer surface of the third adsorbent 4. As a result, it is possible to inhibit the formation of the gap between the inner surface of the inner case 6 and the outer surface of the third adsorbent 4. This contributes to making the evaporated fuel adsorption capacity of the evaporated fuel treatment device 1 less prone to decrease and inhibiting displacement of the third adsorbent 4 relative to the inner case 6.

(1b) The thermal expansion coefficient of the inner case 6 is, for example, equal to or greater than the thermal expansion coefficient of the outer case 5. In such a configuration, it is possible to inhibit expansion of the outer case 5 relative to the inner case 6. Therefore, in a case where the heat has been transferred to the outer case 5 and the inner case 6, and consequently, the outer case 5 and the inner case 6 try to expand, it is possible to make the compressive force Y1 act on the elastic member 7 more strongly. Accordingly, it is possible to make the reaction force Y2 act on the inner case 6 more strongly. Consequently, it is possible to further inhibit the formation of the gap between the inner surface of the inner case 6 and the outer surface of the third adsorbent 4.

(1c) The at least a portion of the third adsorbent 4 is, for example, press-fitted into the inner case 6. In other words, the at least a portion of the third adsorbent 4 is, for example, disposed inside the inner case 6 in a state where the at least a portion of the third adsorbent 4 is compressed radially inward by the inner case 6. In such a configuration, even if the inner case 6 expanded due to the heat, the third adsorbent 4 expands radially outward to the same extent. Therefore, it is possible to further inhibit the formation of the gap between the inner surface of the inner case 6 and the outer surface of the third adsorbent 4.

(1d) The inner case 6 includes the groove 62. The elastic member 7 is disposed in the groove 62. In such a configuration, it is possible to inhibit the displacement of the elastic member 7 in the axial directions of the inner case 6. Therefore, it is possible to more easily obtain the effects of the above-described (1a).

(1e) The length L1 of the third adsorbent 4 is smaller than the equivalent diameter D1 of a cross-section of the third adsorbent 4. In such a configuration, it is possible to obtain the effects of the above-described (1a) while further reducing the ventilation resistance of the third adsorbent 4.

(1f) The third adsorbent 4 and the elastic member 7 are housed in the third adsorption chamber 56. The third adsorption chamber 56 is directly coupled to the atmosphere port 53. In such a configuration, it is possible to obtain the effects of the above-described (1a) for the third adsorbent 4 that is adjacent to the atmosphere port 53.

### 2. Second Embodiment

### [2-1. Configuration]

Since a basic configuration of the second embodiment is similar to that of the first embodiment, differences will be described below. It should be noted that the same reference numeral as that in the first embodiment indicates the same configuration, and reference is made to the preceding description.

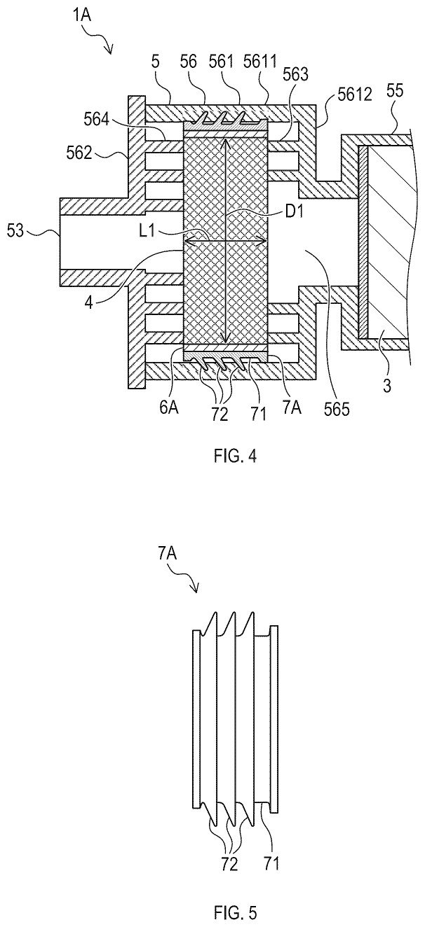

FIG. 4 is a cross-sectional view of a part, including the third adsorption chamber 56, of an evaporated fuel treatment device 1A of the second embodiment. As shown in FIG. 4, the evaporated fuel treatment device 1A of the second embodiment differs from the evaporated fuel treatment device 1 of the first embodiment in that the evaporated fuel treatment device 1A includes an inner case 6A and an elastic member 7A instead of the inner case 6 and the elastic member 7, which are described above.

The inner case 6A and the above-described inner case 6 have substantially the same configuration. However, the inner case 6A does not include the groove 62.

The elastic member 7A is a tubular member having elasticity. As shown in FIG. 5, the elastic member 7A includes a tube portion 71 and at least one (three in an example shown in FIG. 5) flange portion 72. The tube portion 71 has a tubular shape. The flange portion 72 extends radially outward from the tube portion 71 and is continuously formed around the entire circumference of the tube portion 71 in its circumferential directions.

As shown in FIG. 4, the elastic member 7A is disposed between an outer surface of the inner case 6A and the inner surface of the outer case 5 in a state where the elastic member 7A is compressed radially inward. Specifically, the elastic member 7A is disposed between the outer surface of the inner case 6A and the inner surface of the main body portion 561 in a state where the elastic member 7A is compressed radially inward. The elastic member 7A surrounds both the inner case 6A and the third adsorbent 4 in circumferential directions of the inner case 6A. The elastic member 7A covers the entire region of the inner case 6A along axial directions of the inner case 6A from a radially outside of the inner case 6A. The elastic member 7A covers the entire region of the third adsorbent 4 along the axial directions of the inner case 6A from the radially outside of the inner case 6A.

FIG. 4 shows a configuration, as one example, in which the flange portion 72 is embedded in the surrounding wall 5611 of the main body portion 561. However, the elastic member 7A may be housed in the main body portion 561 in a state where the flange portion 72 is not embedded in the surrounding wall 5611 by, for example, the flange portion 72 being curved radially inward.

### [2-2. Effects]

The second embodiment explained above in detail provides similar effects as those of the above-described (1a) to (1c), (1e), and (1f), and further provides the following effects.

(2a) The elastic member 7A covers the entire region of the inner case 6A along the axial directions of the inner case 6A from the radially outside of the inner case 6A. With such a configuration, in a case where the inner case 6A tries to expand due to the heat, it is possible to make the reaction force act on the entire region of the inner case 6A along the axial directions of the inner case 6A. Therefore, it is possible to further inhibit the expansion of the inner case 6A due to the heat. Consequently, it is possible to further inhibit formation of a gap between an inner surface of the inner case 6A and the outer surface of the third adsorbent 4.

(2b) The elastic member 7A includes the at least one flange portion 72. In such a configuration, it is possible to further inhibit displacement of the elastic member 7A relative to the outer case 5 compared to a configuration in which the elastic member does not include the at least one flange portion 72. Therefore, it is possible to more easily obtain the effects of the above-described (2a).

### 3. Third Embodiment

### [3-1. Configuration]

Since a basic configuration of a third embodiment is similar to that of the first embodiment, differences will be described below. It should be noted that the same reference numeral as that in the first embodiment indicates the same configuration, and reference is made to the preceding description.

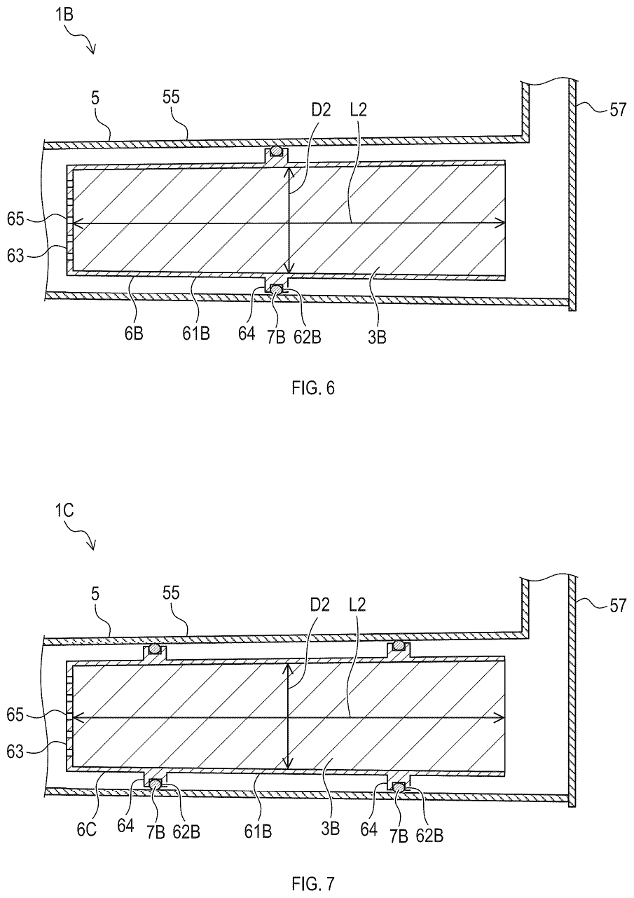

FIG. 6 is a cross-sectional view of a part, including the second adsorption chamber 55, of an evaporated fuel treatment device 1B of the third embodiment. As shown in FIG. 6, the evaporated fuel treatment device 1B includes a second adsorbent 3B instead of the above-described second adsorbent 3. In addition, the evaporated fuel treatment device 1B further includes an inner case 6B and an elastic member 7B.

The second adsorbent 3B is, similarly to the above-described second adsorbent 3, configured to adsorb the evaporated fuel. The second adsorbent 3B is in the form of a mass. An external shape of the second adsorbent 3B is a columnar shape.

The inner case 6B has a bottomed tubular shape. The inner case 6B includes a surrounding wall 61B, a bottom wall 63, an annular portion 64, and a groove 62B.

The surrounding wall 61B has a tubular shape.

The bottom wall 63 has, for example, a plate shape. Two or more through holes 65 are formed in the bottom wall 63. The bottom wall 63 partially blocks one opening of the surrounding wall 61B in its axial directions.

The annular portion 64 has an annular shape. The annular portion 64 extends radially outward from the surrounding wall 61B and is continuously formed around the entire circumference of the surrounding wall 61B in its circumferential directions. As will be described below, at least a portion of the second adsorbent 3B is disposed in a space surrounded by the surrounding wall 61B. The annular portion 64 is formed on a portion of the surrounding wall 61B that surrounds the second adsorbent 3B in its circumferential directions.

The groove 62B is a recess formed on an end surface of the annular portion 64. The end surface of the annular portion 64 is a radially outer side surface of the annular portion 64. The groove 62B is continuously formed around the entire circumference of the surrounding wall 61B in its circumferential directions.

The at least a portion (for example, the whole) of the second adsorbent 3B is disposed in the space surrounded by the surrounding wall 61B. That is, the at least a portion (for example, the whole) of the second adsorbent 3B is disposed inside the inner case 6B. The inner case 6B is configured to hold the second adsorbent 3B in a state where the at least a portion of the second adsorbent 3B is disposed inside the inner case 6B. In one example, the at least a portion of the second adsorbent 3B is press-fitted into the inner case 6B, which thereby enables the inner case 6B to hold the second adsorbent 3B in a state where the at least a portion of the second adsorbent 3B is disposed inside the inner case 6B.

The inner case 6B is housed in the second adsorption chamber 55 in a state where the inner case 6B holds the second adsorbent 3B. That is, the inner case 6B is housed in the second adsorption chamber 55 together with the second adsorbent 3B. The inner case 6B is housed in the second adsorption chamber 55 in a state where the bottom wall 63 faces the third adsorption chamber 56. Gas that has flown into the second adsorption chamber 55 passes inside the inner case 6B, and consequently, through the second adsorbent 3B in axial directions of the inner case 6B.

In a state where the second adsorbent 3B is held by the inner case 6B, a length L2 [mm] of the second adsorbent 3B is larger than an equivalent diameter D2 [mm] of a cross-section of the second adsorbent 3B. The length L2 of the second adsorbent 3B is, more specifically, a length L2 of the second adsorbent 3B along the gas flow directions in the second adsorption chamber 55. The equivalent diameter D2 of a cross-section of the second adsorbent 3B is, more specifically, an equivalent diameter D2 of a cross-section, which is perpendicular to the gas flow directions in the second adsorption chamber 55, of the second adsorbent 3B.

The elastic member 7B has substantially the same configuration as that of the above-described elastic member 7. However, the elastic member 7B is disposed between an outer surface of the inner case 6B and an inner surface of the second adsorption chamber 55. Specifically, the elastic member 7B is disposed in the groove 62B in a state where the elastic member 7B is compressed radially inward. The elastic member 7B surrounds both the inner case 6B and the second adsorbent 3B in circumferential directions of the inner case 6B. The elastic member 7B covers a part of the second adsorbent 3B along the axial directions of the inner case 6B from a radially outside of the inner case 6B.

### [3-2. Effects]

The third embodiment explained above in detail provides similar effects of the above-described (1a) to (1d).

### 4. Fourth Embodiment

### [4-1. Configuration]

Since a basic configuration of a fourth embodiment is similar to that of the third embodiment, differences will be described below. It should be noted that the same reference numeral as that in the third embodiment indicates the same configuration, and reference is made to the preceding description.

FIG. 7 is a cross-sectional view of a part, including the second adsorption chamber 55, of an evaporated fuel treatment device 1C of the fourth embodiment. As shown in FIG. 7, the evaporated fuel treatment device 1C includes an inner case 6C instead of the above-described inner case 6B. The evaporated fuel treatment device 1C includes two elastic members 7B.

The inner case 6C has substantially the same configuration as that of the above-described inner case 6B. However, the inner case 6C includes two annular portions 64 and two grooves 62B. Each of the two grooves 62B is formed in the corresponding one of the two annular portions 64. Each of the two elastic members 7B is disposed in the corresponding one of the two grooves 62B.

### [4-2. Effects]

The fourth embodiment explained above in detail provides similar effects as those of the third embodiment and further provides the following effects.

In the evaporated fuel treatment device 1C of the fourth embodiment, the two elastic members 7B are disposed between an outer surface of the inner case 6C and the inner surface of the second adsorption chamber 55. With such a configuration, in a case where the inner case 6C tries to expand due to the heat, it is possible to make the reaction force act on the inner case 6C from each of the two elastic members 7B. Therefore, it is possible to further inhibit expansion of the inner case 6C due to the heat. Consequently, it is possible to further inhibit formation of a gap between an inner surface of the inner case 6C and an outer surface of the second adsorbent 3B.

### 5. Other Embodiments

Although the embodiments of the present disclosure have been described, the present disclosure is not limited to the above-described embodiments and may be practiced in various other forms.

(5a) In the third adsorption chamber 56, the at least a portion of the third adsorbent 4 is disposed inside the inner case 6. That is, as in the above-described embodiments, the whole of the third adsorbent 4 may be disposed inside the inner case 6, or only a portion of the third adsorbent 4 may be disposed inside the inner case 6. In a case where only a portion of the third adsorbent 4 is disposed inside the inner case 6, the remaining portion of the third adsorbent 4 extends outward beyond the inner case 6. The same applies to the inner case 6B in the above-described third embodiment and the inner case 6C in the above-described fourth embodiment.

(5b) In the above-described embodiments, the length L1 of the third adsorbent 4 is smaller than the equivalent diameter D1 of a cross-section of the third adsorbent 4. However, the equivalent diameter of a cross-section of the third adsorbent relative to the length of the third adsorbent is not particularly limited. For example, the length of the third adsorbent may be equal to the equivalent diameter of a cross-section of the third adsorbent or may be greater than the equivalent diameter of a cross-section of the third adsorbent. The same applies to the first adsorbent and the second adsorbent.

(5c) In the above-described embodiments, the third adsorption chamber 56 includes the at least one bottom-side supporting column portion 563, and the at least one lid-side supporting column portion 564. However, for example, the third adsorption chamber does not have to include at least one of the at least one bottom-side supporting column portion and the at least one lid-side supporting column portion. Even in a case where the third adsorption chamber does not include the supporting column portions, the position of the inner case relative to the third adsorption chamber can be maintained by the elastic member.

(5d) In the above-described embodiments, the evaporated fuel treatment devices 1, 1A, 1, and 1C include the first adsorption chamber 54, the second adsorption chamber 55, and the third adsorption chamber 56. However, the number of adsorption chambers included in the evaporated fuel treatment device is not particularly limited and may be, for example, one or more.

(5e) Functions of one element in the above-described embodiments may be achieved by two or more elements, or functions of two or more elements may be integrated into one element. A part of the configurations in the above-described embodiments may be omitted. At least a part of the configurations in the above-described embodiments may be added to or replaced with other part of the configurations in the above-described embodiments.

What is claimed is:

1. An evaporated fuel treatment device comprising:
an adsorbent in a form of a mass, the adsorbent being configured to adsorb evaporated fuel;
an inner case that has a tubular shape, the inner case being configured to hold the adsorbent in a state where at least a portion of the adsorbent is disposed inside the inner case;
an outer case that houses the adsorbent and the inner case; and
an elastic member that is disposed between an outer surface of the inner case and an inner surface of the outer case, the elastic member surrounding both the inner case and the adsorbent in circumferential directions of the inner case.

2. The evaporated fuel treatment device according to claim 1,
wherein the elastic member is disposed between the outer surface of the inner case and the inner surface of the outer case in a state where the elastic member is compressed by the outer case in a radially inward direction of the inner case as a result of the inner case being housed in the outer case.

3. The evaporated fuel treatment device according to claim 2,
wherein a groove is formed on the outer surface of the inner case, and
wherein the elastic member is an annular member that is disposed in the groove.

4. The evaporated fuel treatment device according to claim 2,
wherein the elastic member comprises:
a tube portion that has a tubular shape and covers the outer surface of the inner case; and
a flange portion that extends from the tube portion in a radially outward direction of the tube portion and that is continuously formed around an entire circumference of the tube portion in its circumferential directions.

5. The evaporated fuel treatment device according to claim 1,
wherein a thermal expansion coefficient of the inner case is equal to or greater than a thermal expansion coefficient of the outer case.

6. The evaporated fuel treatment device according to claim 1,
a length of the adsorbent along gas flow directions is smaller than an equivalent diameter of a cross-section of the adsorbent, the cross-section being perpendicular to the gas flow directions.

7. The evaporated fuel treatment device according to claim 1,
wherein the outer case comprises:
an atmosphere port that is open to atmosphere; and
an atmosphere-side adsorption chamber that is directly coupled to the atmosphere port,
wherein the adsorbent and the elastic member are housed in the atmosphere-side adsorption chamber.

8. The evaporated fuel treatment device according to claim 1,
wherein the outer case comprises:
a surrounding wall portion that has a tubular shape and surrounds the adsorbent and the inner case, the surrounding wall portion including a first opening located on one side in its axial directions and a second opening located on an other side in its axial directions;
a first blocking wall portion that has a plate shape and partially blocks the first opening; and
a second blocking wall portion that has a plate shape and partially blocks the second opening,
wherein the outer case further comprises at least one of:
a first supporting column portion that extends from the first blocking wall portion toward the second blocking wall portion; and
a second supporting column portion that extends from the second blocking wall portion toward the first blocking wall portion.
